(19) United States
(12) Patent Application Publication
(10) Pub. No.: US 2015/0378048 A1
(43) Pub. Date: Dec. 31, 2015

(54) Inspection of Baggage from within a Conveyance

(71) Applicant: American Science and Engineering, Inc., Billerica, MA (US)

(72) Inventors: Jeffrey R. Schubert, Somerville, MA (US); Lee Grodzins, Lexington, MA (US); Jason Toppan, Burlington, MA (US); Michael Wilson, Cambridge, MA (US)

(21) Appl. No.: 14/726,743

(22) Filed: Jun. 1, 2015

Related U.S. Application Data
(60) Provisional application No. 62/017,994, filed on Jun. 27, 2014.

(51) Int. Cl. G01V 5/00; G01N 23/04

(52) U.S. Cl. CPC G01V 5/0066; G01V 5/0025; G01N 23/04

(57) ABSTRACT

Methods and apparatus for parcel inspection with x-rays. A source of penetrating radiation contained entirely within an enclosing body of a conveyance generates a beam of penetrating radiation incident upon a parcel while the parcel is disposed externally to the enclosing body. A detector generates an inspection signal based on detection of penetrating radiation after interaction with contents of the parcel. A conveyor positions the parcel with respect to the beam of penetrating radiation, while a processor ascertains a specified characteristic of the parcel based on the inspection signal.

The present Application claims the priority of U.S. Provisional Application Ser. No. 62/017,994, filed Jun. 27, 2014, and incorporated herein by reference in its entirety.

### TECHNICAL FIELD

The present invention relates to systems and methods for inspection of baggage or parcels using penetrating radiation, and, more particularly to systems and methods for scanning baggage or parcels that are disposed outside a road-worthy vehicle, wherein the methods use penetrating radiation emitted from within the vehicle.

### BACKGROUND OF THE INVENTION

Various methods are used for non-destructive inspection of parcels using penetrating radiation. The radiation (which may be electromagnetic, such as X-rays or gamma rays, or may be comprised of particles such as neutrons) is emitted by one or more sources and impinges upon an article to be inspected. Similarly, well-known methods are used to pass the penetrating radiation through parts, or the entire volume, of the inspected article. Passing the penetrating radiation through the inspected volume typically entails scanning, which is to say that the entire volume is not irradiated at once. The penetrating radiation is typically formed into a beam, and the beam profile may have various shapes, such as that of a pencil, or a fan, or a cone. In any event, passing the beam through the inspected volume may be referred to as “scanning ” Scanning may entail moving the beam, and/or moving the inspected article. A system for moving parcels relative to an inspecting beam of penetrating radiation (or vice versa) may be referred to herein as a “scanning system.”

Parcels are routinely inspected using free-standing X-ray inspection devices, as shown in FIG. 1A, installed at airports, border crossings, and public buildings. In some cases, it is desirable to provide for ready mobility of the inspection device, such as at public events, or upon arrival of vessels or aircraft. For such applications, X-ray inspection devices have been mounted in trailers (as shown in FIG. 1B) or in vans (as shown in FIG. 1C). In those cases, parcels must be passed into, or through, the respective trailers or vans, and inspection occurs on the inside of the conveyances.

All existing systems for inspecting parcels using X-rays emitted from inside a vehicle have always required that the parcels actually be introduced into the confines of the vehicle itself. “Vehicle,” as the term is used here, includes any conveyance that can be moved from one place to another, whether under its own power, or drawn, or otherwise moved, by a powered vehicle. It has never been considered possible to inspect such objects outside of the confines of the same conveyance containing the x-ray source because of considerations of beam geometry.

Any configuration whereby baggage or parcels might be inspected using an X-ray source contained within a vehicle but without introducing the scanned items into the confines of the vehicle would be useful in a variety of contexts, such as the offloading of baggage from aircraft.

### SUMMARY OF EMBODIMENTS OF THE INVENTION

In accordance with embodiments of the present invention, a parcel inspection system is provided that has a first conveyance with an enclosing body and with a source of penetrating radiation contained entirely within the enclosing body. The source is adapted to generate a beam of penetrating radiation incident upon a parcel while the parcel is disposed externally to the enclosing body, and a detector, contained entirely within the body of the first conveyance, for generating a scatter signal based on penetrating radiation scattered by contents of the parcel. The parcel inspection system also has a conveyor for positioning the parcel with respect to the beam of penetrating radiation, and a processor adapted to ascertain a specified characteristic of the parcel based on the inspection signal.

In other embodiments of the present invention, the detector may include a scatter detector, contained entirely within the body of the first conveyance, for generating a scatter signal based on penetrating radiation scattered by contents of the parcel. The specified characteristic ascertained by the processor may include an image of contents of the parcel. The conveyor may include a motorized belt and may be enclosed within an inspection tunnel, and, also, within a second conveyance, which may be a self-propelled vehicle or a trailer. The parcel inspection system may also have a transmission detector, or a forward scatter detector, disposed distally to the parcel with respect to the source of penetrating radiation. Both the conveyor for positioning the parcel and the transmission detector and/or one or more scatter detectors may be enclosed within a second conveyance.

In accordance with another aspect of the present invention, a method is provided for inspecting a parcel. The method has steps of:

scanning penetrating radiation upon the parcel while the parcel is disposed externally to the enclosing body;

detecting radiation using a scatter detector contained entirely within the body of the enclosed conveyance, for generating a scatter signal based on penetrating radiation scattered by contents of the parcel; and

ascertaining a specified characteristic of the contents of the parcel based on the scatter signal.

The specified characteristic of the contents of the parcel ascertained by the method may include an image, or may include material information such as effective atomic number, etc.

### BRIEF DESCRIPTION OF THE DRAWINGS

The foregoing features of the invention will be more readily understood by reference to the following detailed description, taken with reference to the accompanying drawings, in which:

FIGS. 1A-1C depict prior art x-ray parcel inspection devices that are, respectively, free-standing, trailer-borne, and van-borne.

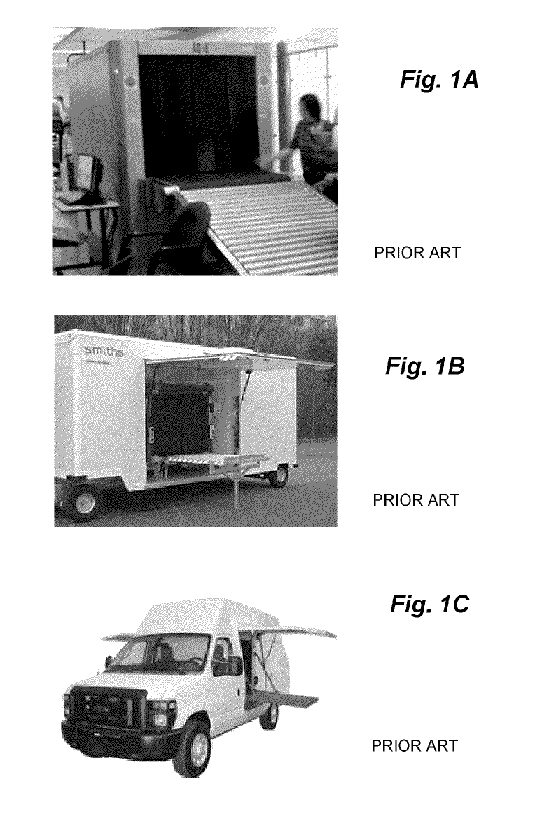

FIG. 2 is a perspective view, cutaway in part, of a prior art mobile cargo inspection system deployed on a truck capable of on-road travel and scanning of an enclosure such as a vehicle or cargo container while one or both of the inspection system and enclosure are in motion, in accordance with preferred embodiments of the present invention; and

FIG. 3 shows a rear view of a parcel scanning system, in accordance with an embodiment of the present invention.

### DETAILED DESCRIPTION OF EMBODIMENTS OF THE INVENTION

Definitions: As used herein, and in any appended claims, the terms “baggage” and “parcel” may be used interchangeably to mean an object of inspection.

A “conveyance” shall be any device characterized by a platform borne on ground-contacting members such as wheels, tracks, treads, skids, etc., used for transporting equipment from one location to another.

The word “conveyor,” as used herein and in any appended claims, shall refer to any handling equipment designed and suited for moving a parcel from one place to another. A conveyor may employ rollers or a belt, driven by chains or otherwise, however other conveyor mechanisms are subsumed within the scope of the present invention.

The word “image,” as used herein and in any appended claims, shall refer to any multidimensional representation, whether in tangible or otherwise perceptible form, or otherwise, whereby a value of some characteristic (amplitude, phase, etc.) is associated with each of a plurality of locations corresponding to dimensional coordinates of an object in physical space, though not necessarily mapped one-to-one thereonto. Thus, for example, the graphic display of the spatial distribution of some field, either scalar or vectorial, such as brightness or color, or x-ray scatter intensity, etc., constitutes an image. So, also, does an array of numbers, such as a 3D holographic dataset, in a computer memory or holographic medium. Similarly, “imaging” refers to the rendering of a stated physical characteristic in terms of one or more images.

The word “trailer,” as used herein and in any appended claims, shall refer to a conveyance adapted to be drawn over an underlying surface by a motorized vehicle that may be referred to herein as a “tractor.”

The term “X-ray source” shall signify a device that produces X-rays, including, without limitation, X-ray tubes, or Bremsstrahlung targets impinged upon by energetic particles, without regard for the mechanism used to generate the X-rays, including, without limitation, linacs, etc.

The systems and methods described herein may be described in terms of X-rays, however the applicability of the teachings to other spectral ranges is clear, and encompasses, within the scope of the invention, all manner of penetrating radiation, including, for example, gamma rays or neutrons.

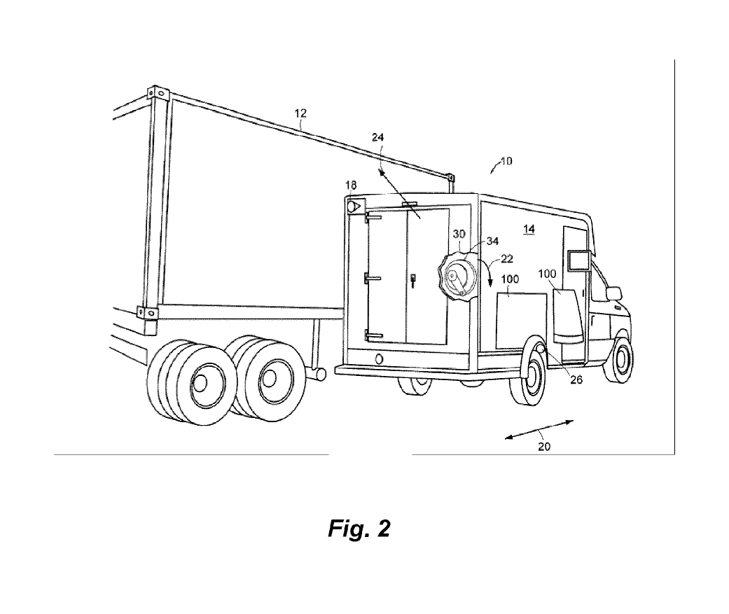

Referring now to FIG. 2, preferred embodiments of this invention make use of systems, such as the prior art inspection van 10, on which a source 30 of penetrating radiation is mounted, and which, in prior practice, was typically used for X-ray inspection of large objects to be inspected such as a vehicle 12 or a cargo container. Inspection van 10 may also be referred to herein as a conveyance, in that, in the scope of the present invention, conveyance 10 is not limited to embodiment as a van. Conveyance 10 is characterized by an enclosure 14, here, the skin of a van, shown, in cutaway view, to enable depiction of other components of an inspection system. The conveyance 10 can have many alternate embodiments, including but not limited to gasoline, diesel, electric, propane, battery, fuel-cell, or hydrogen-powered motor vehicles (including vans, trucks, or similar), tracked vehicles, sleds, trailers, cranes, or other equipment that can be put into motion, preferably self-propelled, but also including vehicles tethered and pulled such as under electric power.

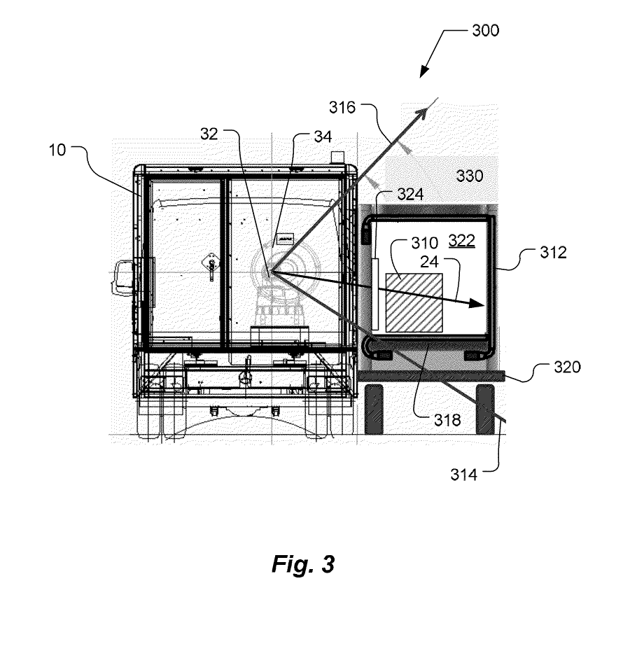

Contained within enclosure 14 of conveyance 10 is a source 30 including X-ray tube 32 (shown in FIG. 3) and chopper 34. In accordance with preferred embodiments of the invention, source energies are typically below 250 keV, thus the chopper 34 may be smaller than that employed in other systems that perform inspection using higher-energy X-rays. It is to be understood that the scope of the present invention is not limited to particular energy ranges, and may include X-rays of energies substantially higher than 250 keV. Chopper 34 may be a rotating perforated hub, or a wheel with transmitting spokes, or any number of means, known in the art, for generation of flying spot beams that lie, typically, in a plane approximately orthogonal to the direction of motion 20 of the conveyance 10. The X-ray tube 32 may generate a fan beam, or may be a panoramic-style x-ray tube that is capable of wide-angle beam generation, and additionally may be rotatable to allow scanning on either side of conveyance 10. Chopper 34 emits a pencil beam 24, thereby enabling inspection of objects, possibly on either side of the conveyance, herein referred to as “bilateral” inspection. However, all sources are encompassed within the scope of the present invention when employed in the manner described in the present description. Detectors 100 may be concealed within conveyance 10 as shown in FIG. 2, and serve to detect X-rays scattered by contents of inspected object 12. The X-ray source and detectors may be oriented to permit scanning from the conveyance's “driver's side”, “passenger's side”, or both sides simultaneously. Conveyance 10 may be capable of being driven by means of an electrical drive coupled to a tire by friction drive 26,

Various means are known in the art for mechanically or electronically sweeping a beam of penetrating radiation, including, for example, the rotating chopper wheel 34 depicted in FIG. 2 or electronic scanning is described in detail, for example, in U.S. Pat. No. 6,421,420, issued Jul. 16, 2002, which is incorporated herein by reference. In embodiments employing a mechanical rotating chopper wheel 34, as the chopper wheel rotates in the direction of arrow 22, penetrating radiation 24 emitted from the target of X-ray tube 32 passes successively through a plurality (typically, three or four) of channels within the chopper wheel. Wheel 34 is fabricated from a material, typically lead, that blocks transmission of X-rays except through apertures (not shown). X-rays 24 emerge from the currently illuminated channel as a pencil beam 24 that is swept across object 12 undergoing inspection as wheel 34 rotates. The dimensions of the beam 24 typically govern the resolution of a system such as the one depicted. Other X-ray generation approaches may be used to produce a similar sweeping pencil beam, such as spinning discs with elongated slits, or wheels with hollow spokes, all of which are examples of alternate embodiments.

Detector modules 100 are carried by conveyance 10 and typically enclosed within enclosing body 14 and concealed from view from outside the conveyance. They may also be carried outside the conveyance for particular applications. Detector modules contain detectors for detecting penetrating radiation from source 30 that has interacted with, and scattered from, contents of the inspected object 12.

Detector modules 100 may also be sensitive both to emission naturally emitted by threat materials, as further described, for example, in U.S. Pat. No. 8,325,871, entitled “Radiation Threat Detection,” which is incorporated herein by reference. In accordance with various embodiments of the present invention, a detector may also be employed of the type having high efficiency for detecting thermal and epi-thermal (intermediate energy, typically 1-10⁴ eV) neutrons.

For backscatter operation, large-area detectors 100 are deployed adjacent to the beam plane on the X-ray source side of the scanned object, and with their active surfaces oriented toward the scanned object. These detectors need only provide a large solid angle for collection of scattered radiation; no critical alignments are required. In this location these detectors respond to X-rays which are scattered generally back toward the source from the object.

A parcel inspection system in accordance with an embodiment of the present invention is now described with reference to FIG. 3, where the parcel inspection system is designated generally by numeral 300. A source of penetrating radiation 30 is contained within conveyance 10, as described above, with reference to FIG. 2. In accordance with the present invention, conveyance 10 is used, however, not only for the inspection of large cargo or vehicles, but to inspect baggage or small parcels 310. Beam 24 of penetrating radiation traverses parcel 310 and is detected by a transmission detector 312. It is to be understood that the term “transmission detector” applies to the entirety of the apparatus used to detect that component of beam 24 which traverses parcel 310. Transmission detector 312 may be segmented, within the scope of the present invention. “Detection” refers to generating a detector signal on the basis of detecting radiation from source 30 that has interacted with the parcel and its contents, or radiation that emanates from parcel 310 in the absence of an incident beam.

In preferred embodiments of the present invention, beam 24 is scanned in a vertical beam plane, by rotation of chopper wheel 34, between angular scanning limits depicted by rays 314 and 316. It is to be understood that, since inspection conveyance 10 may be used for cargo inspection purposes as well as for the purposes described herein, it may be advantageous to vary the scanning parameters, such as angular scanning limits or resolution, when inspection conveyance 10 is used for inspecting parcels. In order to scan parcel 310 in the dimension into the plane of FIG. 3, parcel 310 is moved in the direction into the plane of FIG. 3 by a conveyor 318. Conveyor 318 may be any handling equipment designed and suited for moving a parcel from one place to another. Conveyor 318 may employ rollers or a belt, driven by chains or otherwise, for example, however other conveyor mechanisms are subsumed within the scope of the present invention.

Conveyor 318, as well as transmission detector 312, may be located within a second conveyance 320, which may be a capable of self-propulsion, or, alternatively, may be a trailer, capable of being drawn by conveyance 10 (the inspection van), or by another tractor. Second conveyance 320 may be referred to herein as a “parcel conveyance.” The region spanned by beam 24 as it is scanned may be referred to herein as a “tunnel” 322 or “scanning tunnel,” and has an area, in some embodiments, that is as large as 1.5 m×1.5 m, thereby accommodating certain LD3 aircraft containers, for example. For heavier parcels, a lead-in conveyor (not shown) may be employed to feed parcels 310 onto conveyor 318.

In accordance with further embodiments of the invention, one or more scatter detectors 324 may also be disposed within the second conveyance 320, generating a scatter signal that contributes to the inspection signal used to characterize contents of the parcels. Under certain circumstances, advantages may accrue from deploying backscatter detectors at distinct distances from the inspected object, as has been taught, to cite one example, in U.S. Pat. No. 6,424,695, entitled “Separate Lateral Processing of Backscatter Signals,” which is incorporated herein by reference. Additionally, or alternatively, one or more side scatter detectors (not shown) may be deployed within the second conveyance 320. Scatter detectors within second conveyance 320 may also include forward scatter detectors, disposed distal to the inspected parcels with respect to the X-ray source.

Based on penetrating radiation that has traversed parcel 310, transmission detector 312 generates a transmission signal that constitutes an inspection signal, or a portion of an inspection system, received by a processor 330. Processor 330 may be located, in whole or in part, within the second conveyance 320, and may be located, in whole or in part, within the first conveyance 10.

In addition to a transmission signal provided by transmission detector 312, information may be derived from penetrating radiation scattered by contents of parcel 310 and detected by scatter detector 100 aboard first conveyance 10. In response, scatter detector 100 generates a scatter signal which may contribute a portion of the inspection signal employed by processor 330 to derive one or more specified characteristics of the parcel.

Among advantages of the present invention is an enhanced throughput of parcels 310 through inspection system 300 made possible by the high beam power (˜3000 W) characteristic of cargo inspection vehicles 10, greatly exceeding the beam power (˜140 W) more typical of fixed parcel inspection systems.

Parcel conveyance 320 may derive a portion, or, preferably, all, of its electrical power from first conveyance 10. This power may be used to power conveyor 318, and for any electronics aboard the parcel conveyance.

Many variants of the system described above are evident to persons of ordinary skill in the inspection arts, and are encompassed within the scope of the present invention. For example, inspection of parcels by means of penetrating radiation transmitted through the parcels, at one range of energies, or at multiple ranges of energies, may be practiced with a single beam or with multiple beams, as described, for example, in US Published Patent Application Ser. No. US 2013/0136230 (entitled “System and Methods for Multi-Beam Inspection of Cargo in Relative Motion,” and incorporated herein by reference).

A parcel inspection system in accordance with various embodiments of the present invention described herein, may advantageously be moved from one location to another in a matter of minutes. It may be used to inspect baggage offloaded from an arriving aircraft for example. Additionally, since conveyance 10 containing the source 30 of penetrating radiation may serve as a backscatter inspection platform, one piece of capital equipment may serve to perform two missions.

Where examples presented herein involve specific combinations of method acts or system elements, it should be understood that those acts and those elements may be combined in other ways to accomplish the same objectives of modular inspection with penetrating radiation. Additionally, single device features may fulfill the requirements of separately recited elements of a claim. The embodiments of the invention described herein are intended to be merely exemplary; variations and modifications will be apparent to those skilled in the art. All such variations and modifications are intended to be within the scope of the present invention as defined in any appended claims.

We claim:

1. A parcel inspection system, the system comprising:
a. a first conveyance characterized by an enclosing body;
b. a source of penetrating radiation contained entirely within the enclosing body of the first conveyance for generating a beam penetrating radiation incident upon a parcel while the parcel is disposed externally to the enclosing body;
c. a detector for generating an inspection signal based on detection of penetrating radiation interacting with contents of the parcel;
d. a conveyor for positioning the parcel with respect to the beam of penetrating radiation; and
e. a processor adapted to ascertain a specified characteristic of the parcel based on the inspection signal.

2. A parcel inspection system in accordance with claim 1, wherein the detector includes a scatter detector, disposed within the body of the first conveyance, for generating a scatter signal based on penetrating radiation scattered by contents of the parcel.

3. A parcel inspection system in accordance with claim 1, wherein the specified characteristic includes an image of contents of the parcel.

4. A parcel inspection system in accordance with claim 1, wherein the conveyor includes a motorized belt.

5. A parcel inspection system in accordance with claim 1, wherein the conveyor is enclosed within an inspection tunnel.

6. A parcel inspection system in accordance with claim 1, wherein the conveyor is enclosed within a second conveyance.

7. A parcel inspection system in accordance with claim 6, wherein the second conveyance is a self-propelled vehicle.

8. A parcel inspection system in accordance with claim 6, wherein the second conveyance is a trailer.

9. A parcel inspection system in accordance with claim 1, wherein the detector includes a transmission detector disposed distally to the parcel with respect to the source of penetrating radiation.

10. A parcel inspection system in accordance with claim 9, wherein the conveyor for positioning the parcel and the transmission detector are both enclosed within a second conveyance.

11. A parcel inspection system in accordance with claim 6, wherein the detector includes a scatter detector disposed within the second conveyance.

12. A parcel inspection system in accordance with claim 11, wherein the scatter detector is at least one of a backscatter detector, a sidescatter detector, and a forward scatter detector.

13. A method for inspecting a parcel, the method comprising:
a. scanning penetrating radiation upon the parcel while the parcel is disposed externally to the enclosing body;
b. detecting radiation using a scatter detector contained entirely within the body of the enclosed conveyance, for generating a scatter signal based on penetrating radiation scattered by contents of the parcel; and
c. ascertaining a specified characteristic of the contents of the parcel based on the scatter signal.

14. A method in accordance with claim 11, wherein the specified characteristic of the contents of the parcel includes an image.
